(19) United States
(12) Patent Application Publication
(10) Pub. No.: US 2005/0057930 A1
(43) Pub. Date: Mar. 17, 2005

(54) Multi-functional bell

(76) Inventor: Wan Chuan Heng, Chunghua (TW)

Correspondence Address: Wan Chuan Heng, 235 Chung-Ho, Box 8-24, Taipei, TW

(21) Appl. No.: 10/660,541

(22) Filed: Sep. 12, 2003

(51) Int. Cl. F21V 33/00

(52) U.S. Cl. 362/253

(57) ABSTRACT

A multi-functional bell comprises a lower semi-round bell and an upper semi-round bell which are combined to have a bell. A sound source is placed in the bell. The colors of the upper semi-round bell and lower semi-round bell are changeable. A space is formed between the upper semi-round bell and lower semi-round bell for receiving gifts so that the bell is formed as a packaging box. An edge of a bottom of the lower semi-round bell is installed with a plurality of rotatable buckling sheets. A plurality of buckle sheets are protruded from the resisting edge. The buckle sheets are alternatively arranged with the rotatable buckling sheets so that the upper semi-round bell is able to be coupled to the lower semi-round bell. An LED lamp is placed in the bell space so that the bell is used as a decoration to be suspended in a Christmas tree.

### FIELD OF THE INVENTION

The present invention relates to bells, and particularly to a multi-functional bell which is formed by an upper semi-round bell and a lower semi-round bell. Colors of the bell is changeable and the bell can be used as a decorating lamp or a packaging box.

### BACKGROUND OF THE INVENTION

The current bells are integrally formed with different sizes. However, these bells are integrally formed and thus they only have the effects of decoration or emitting sound, but cannot be used in other conditions, such as in packaging or as decorating lamps. Moreover, the color of the bell is fixed can not be changed so that the appearance of the bell is dull and unattractive.

### SUMMARY OF THE INVENTION

Accordingly, the object of the present invention is to provide a multi-functional bell which comprises a lower semi-round bell and an upper semi-round bell which are combined to have a bell. A sound source is placed in the bell. The colors of the upper semi-round bell and lower semi-round bell are changeable. A space is formed between the upper semi-round bell and lower semi-round bell for receiving gifts so that the bell being as a packaging box. An edge of a bottom of the lower semi-round bell coupling to the upper semi-round bell is installed with a plurality of rotatable buckling sheets. A plurality of buckle sheets are protruded from the resisting edge. The buckle sheets are alternatively arranged with the rotatable buckling sheets so that the upper semi-round bell is able to be coupled to the lower semi-round bell. An LED lamp is placed in the bell space so that the bell is used as a decoration to be suspended in a Christmas tree.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the present invention.

FIG. 3 is a cross sectional view of the present invention.

FIG. 3A is a partial enlarged view showing the connection portion of the present invention.

FIG. 4 shows one embodiment of the present invention,

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

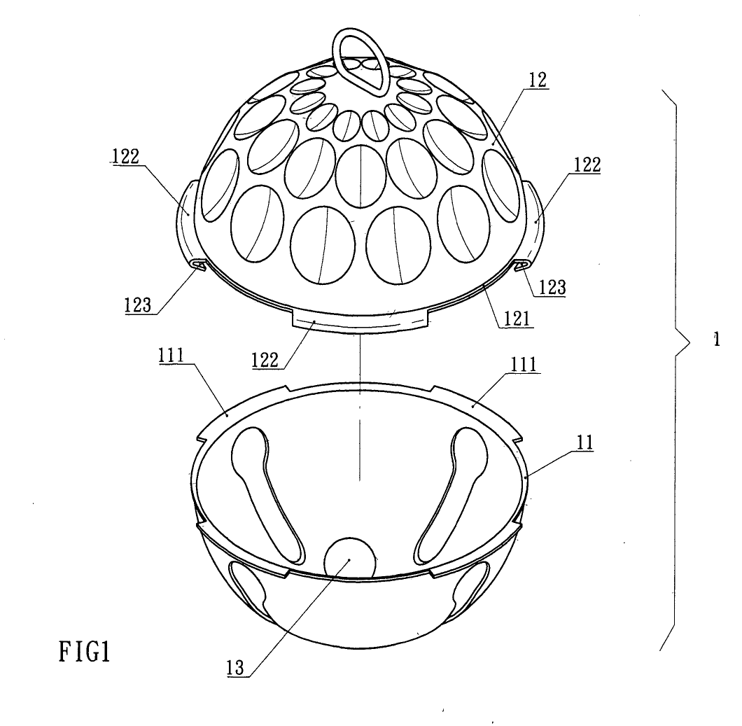

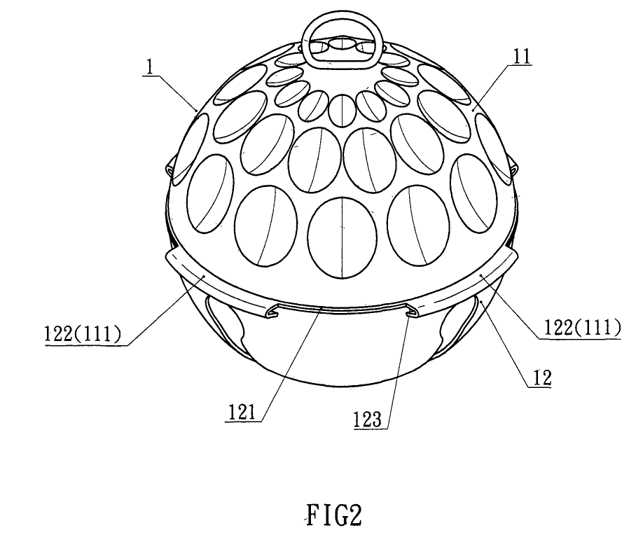

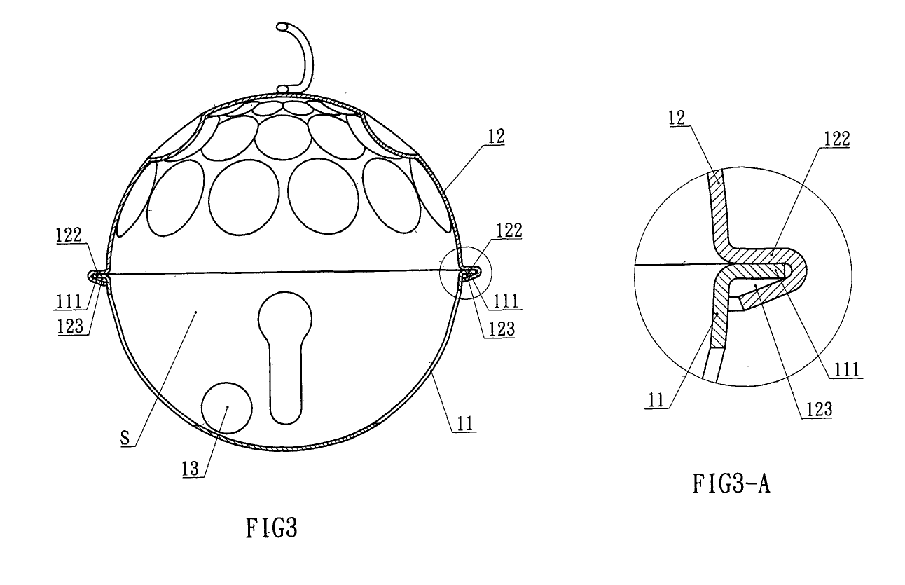

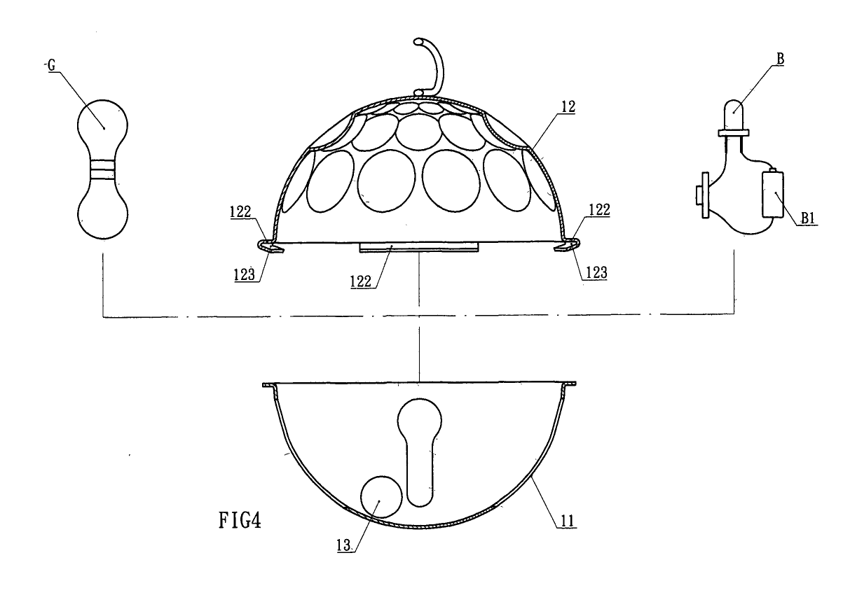

Refer bell to FIGS. 1 and 2, the structure of the present invention is illustrated. The present invention is formed by a lower semi-round bell 11 and an upper semi-round bell 12 which are combined to have a bell 1. A sound source 13 is placed in the bell 1.

An edge of a bottom of the lower semi-round bell 11 coupling to the upper semi-round bell 12 is installed with a plurality of rotatable buckling sheets 111 which are vertically protruded from the edge.

An edge of the upper semi-round bell 12 coupling to the lower semi-round bell 11 is installed with an annular resisting edge 121 for resisting against the rotatable buckling sheets 111. A plurality of buckle sheets 122 are protruded from the resisting edge 121. The buckle sheets 122 are alternatively arranged with the rotatable buckling sheets 111. A U like shape hook portion 123 is formed at a lower end of the buckle sheet 122. When the lower semi-round bell 11 and the upper semi-round bell 12 are coupled, by rotating one of the upper semi-round bell 12 and the lower semi-round bell 11, the buckle sheets 122 are received in the hook portions 123 so that the lower semi-round bell 11 is positioned in the upper semi-round bell 12.

In the present invention, colors of the upper semi-round bell 12 and lower semi-round bell 11 are changeable so as to match the requirement of the user.

When the upper semi-round bell 12 is buckled with the lower semi-round bell 11 as a bell 1, a bell space S is formed within the bell 1 for receiving gifts G. Thereby, the bell 1 can be used as a packaging box. Moreover, the present invention can be formed as a bell used in a Christmas. Not only it is compact and lovely, but also it can be used as required. Furthermore, an LED lamp B with a battery switch B1 can be placed in the bell space S so that the bell 1 is enabled as a decoration to be suspended in a Christmas tree. Thereby, the Christmas tree can flush to present an amusement effect.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A multi-functional bell comprising a lower semi-round bell and an upper semi-round bell which are combined to be formed with a bell; a sound source being placed in the bell; colors of the upper semi-round bell and lower semi-round bell being changeable; a space being formed between the upper semi-round bell and lower semi-round bell for receiving gifts so that the bell being as a packaging box.

2. The multi-functional bell as claimed in claim 1, wherein an edge of a bottom of the lower semi-round bell coupling to the upper semi-round bell is installed with a plurality of rotatable buckling sheets which are vertically protruded from the edge; an edge of the upper semi-round bell coupling to the lower semi-round bell is formed with an annular resisting edge for resisting against the rotatable buckling sheets; a plurality of buckle sheets are protruded from the resisting edge; the buckle sheets are alternatively arranged with the rotatable buckling sheets so that the upper semi-round bell is able to be coupled to the lower semi-round bell by engaging the buckle sheets and the rotatable buckling sheets.

3. The multi-functional bell as claimed in claim 2, wherein a U like shape hook portion is formed at a lower end of each buckle sheet; when the lower semi-round bell and the upper semi-round bell are coupled, by rotating one of the upper semi-round bell and the lower semi-round bell, the buckle sheets are received in the hook portions so that the lower semi-round bell is positioned in the upper semi-round bell.

4. The multi-functional bell as claimed in claim 2, wherein the LED lamp is placed in the bell space so that the bell is used as a decoration to be suspended in a Christmas tree.
